(19) United States
(12) Patent Application Publication
(10) Pub. No.: US 2008/0211662 A1
(43) Pub. Date: Sep. 4, 2008

(54) Self-Calibrating Object Detection System

(76) Inventors: Vernon D. Price, Springfield, TN (US); Brian K. Bell, White House, TN (US)

Correspondence Address: WADDEY & PATTERSON, P.C., 1600 DIVISION STREET, SUITE 500, NASHVILLE, TN, 37203, US

(21) Appl. No.: 11/665,237

(22) PCT Filed: Oct. 14, 2005
(86) PCT No.: PCT/US2005/037213

§ 371 Date: Nov. 7, 2007

Related U.S. Application Data
(60) Provisional application No. 60/619,342, filed on Oct. 15, 2004.

(51) Int. Cl. G08B 23/00

(52) U.S. Cl. 340/527

(57) ABSTRACT

An object detection system (100) for a vehicle includes a clock generator (206) for generating a clock signal. A set of emitters (104) produces and transmits a sensing beam. A set of receivers (112) receives reflected portions of the transmitted sensing beam. A microprocessor (102) controls the object detection system. A gate array (114) receives control signals from the microprocessor and produces transmit signals for the emitters and reference signals for the receivers. The gate array is preferably a field programmable gate array (FPGA).

### TECHNICAL FIELD

The present invention is generally related to object detection systems. More particularly, the present invention is directed toward vehicle-mounted object detection systems utilizing phase delay detection methods.

### BACKGROUND ART

Object detection systems have been developed to alert motor vehicle operators to the presence of another moving vehicle in a monitored zone that extends behind the side mounted vehicle mirror. The monitored zone of interest is commonly referred to as the “blind spot.” Conventional side object detection (SOD) systems use an optical transmitter to transmit detection beams through a transmitter lens into the monitored zone, a receiver to receive detection beams that pass through a receiver lens after being reflected from an object in the monitored zone, and a system board that contains electronic hardware and software for generally controlling the system, including processing the received signals. The system board is electrically coupled to a vehicle electrical bus.

In many SOD systems, multiple detection or sensing beams are transmitted into the monitored detection zone from a light source that uses multiple edge emitting laser diodes. One or more photodetectors are aimed into the monitored zone so that they will receive any reflection of the detection beams from an object in the monitored zone. Such systems typically use triangulation or phase shifts in the received reflections to discriminate between light reflected from objects within the monitored zone and light emanating from beyond the boundaries of the monitored zone. Examples of such systems are disclosed in U.S. Pat. Nos. 5,463,384 and 6,377,167, the contents of which are incorporated by reference.

Prior art object detection systems such as those discussed above require precise calculations to accurately define the detection zone in which the presence of detected objects will result in an alarm. Unfortunately, the performance of many of the components used in prior art object detection systems is affected by varying operational and environmental conditions. For example, the performance of many of the emitter and receiver components of prior art object detection systems varies depending upon the temperature. In addition, many of the discrete electronic components and integrated circuits used in such a system have manufacturing tolerances which result in undesirable variations in the performance of the components. These variations in the performance of the components cause variations in the performance of the object detection system. Avoiding performance degradation arising from such variations requires either individual factory testing and adjustment of each product before it is shipped, additional complex compensation circuitry, or the use of expensive low tolerance components.

Therefore, what is needed is an object detection system for a vehicle that utilizes circuit design and components that are self compensating for temperature and manufacturing tolerance without the need for additional complex compensation circuitry.

### DISCLOSURE OF THE INVENTION

One embodiment of the present invention is directed toward an object detection system for a vehicle. The object detection system includes a clock generator for generating a clock signal. A set of emitters produces and transmits a sensing beam. A set of receivers receives reflected portions of the transmitted sensing beam. A microprocessor controls the object detection system. A gate array receives control signals from the microprocessor and produces transmit signals for the emitters and reference signals for the receivers. The gate array is preferably a field programmable gate array (FPGA). The gate array generates a delayed reference signal for use by the receivers in demodulating the received signal. The gate array includes a delay line having a string of series connected buffers for receiving the clock signal wherein each of the buffers has an associated propagation delay. A series of electrical taps is provided wherein one of the electrical taps is electrically connected after each of the buffers in the string of series connected buffers. A multiplexer receives each of the series of electrical taps with an associated multiplexer input and selectively connects one of the multiplexer inputs to a multiplexer output. Control logic delays the clock signal by a desired amount to generate the delayed signal by selecting an appropriate multiplexer input to connect to the multiplexer output. The control logic periodically recalculates a delay associated with the buffers such that changes in the propagation delays of the buffers caused by variations in component tolerances and operating conditions are compensated for over time. The cumulative delay associated with the delay stages is preferably recalculated by measuring the number of delay stages required to delay the reference signal by one clock cycle. A calibrated tap index can then be calculated based upon the number of taps required to delay the clock signal one clock cycle. A tap select signal is then generated for the multiplexer by the control logic based upon the calibrated tap index and the desired delay.

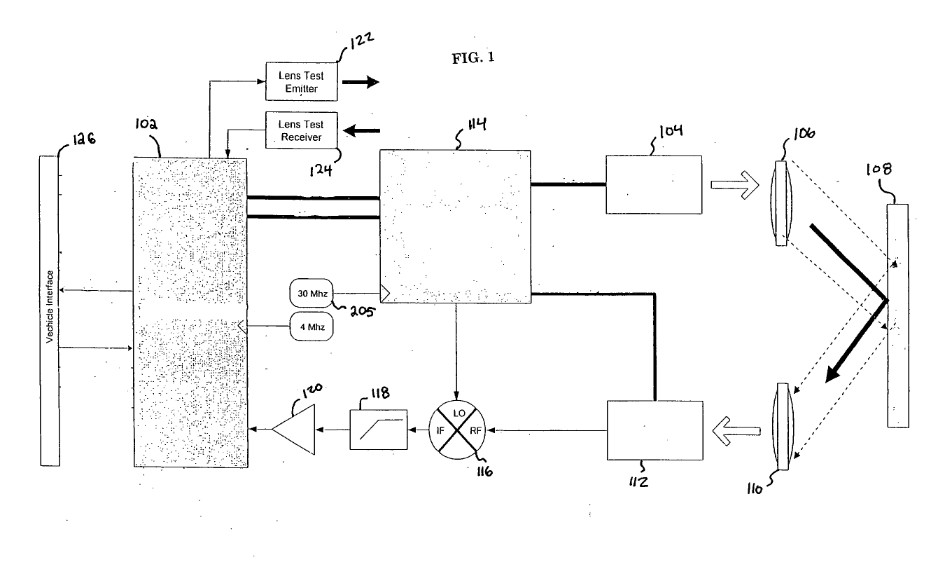

FIG. 1 is a system block diagram of one embodiment of an object detection system in accordance with the present invention.

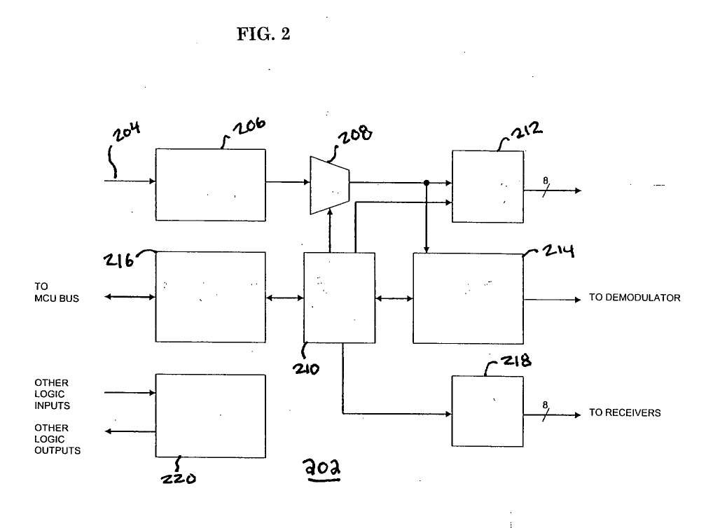

FIG. 2 is a functional block diagram of a gate array constructed in accordance with one embodiment of the present invention.

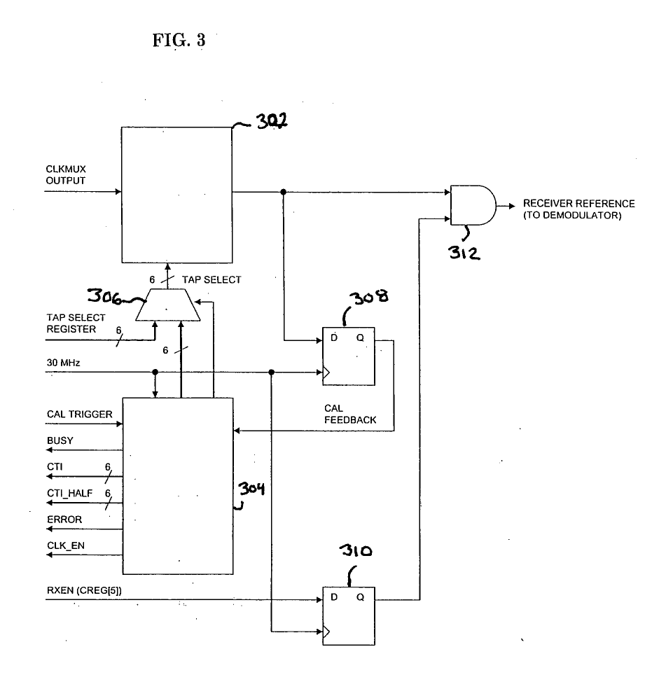

FIG. 3 is a block diagram of a receiver reference module embodied in the gate array of FIGS. 1 and. 2 in accordance with an embodiment of the present invention.

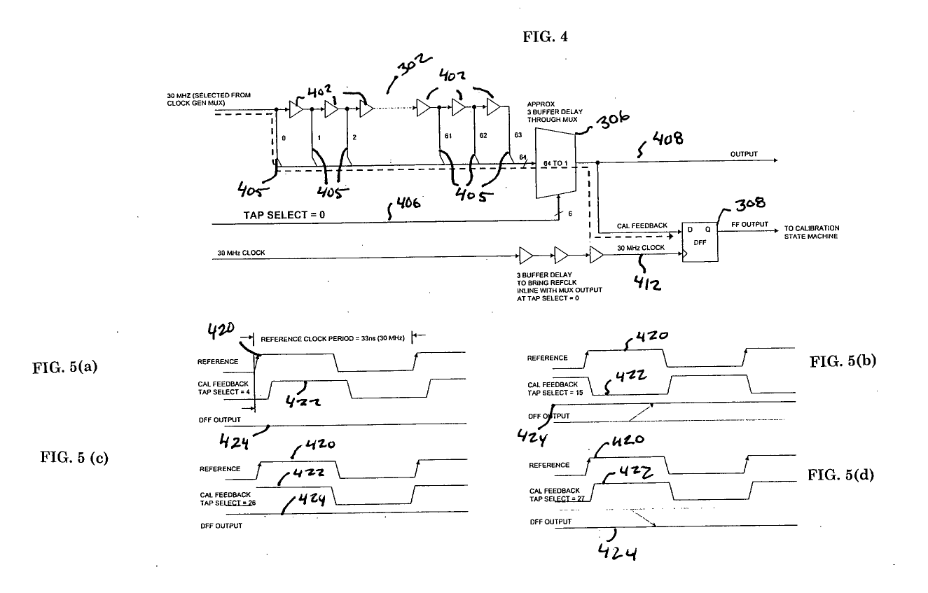

FIG. 4 is a schematic block diagram showing the signal path through the delay and calibration tap circuitry of the present invention.

FIGS. 5(a)-(d) are state timing diagrams illustrating the output of the DFF of FIGS. 3 and 4 as a function of the reference clock signal and calibration feedback signal for different tap selects.

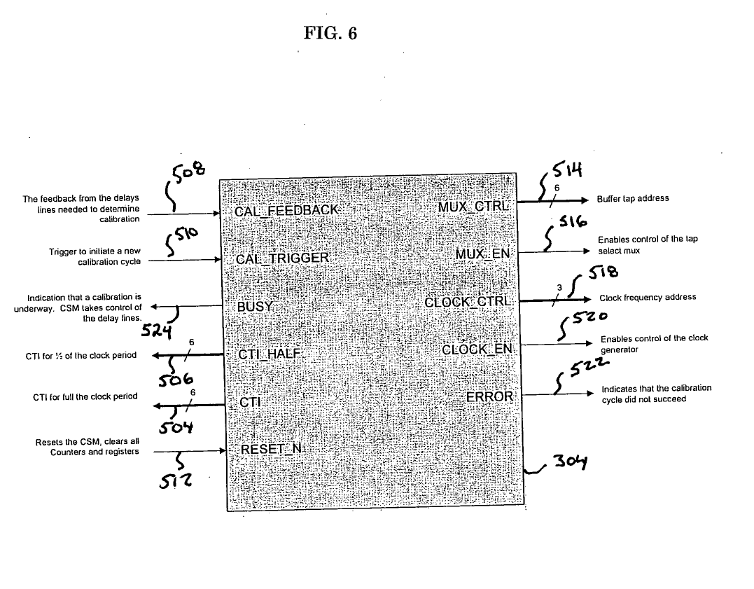

FIG. 6 is a block diagram of one embodiment of a calibration state machine embodied in the gate array of FIGS. 1 and 2 of the present invention.

### BEST MODE FOR CARRYING OUT THE INVENTION

The detection system illustrated and described herein is preferably based upon the Multi Frequency Photoelectric Detection System described in U.S. Pat. No. 6,377,167, the entire contents of which are incorporated herein by reference.

Referring now to FIG. 1, a diagram of an object detection system for a vehicle is shown. The system 100 is managed by a microcontroller 102 that communicates with the vehicle through a vehicle interface. A set of emitters and associated drivers 104 are used to generate infrared optical detection beams that are focused through a lens 106 toward an area in which it is desired to detect a reflecting object 108. The emitters 104 preferably include an array of vertical cavity surface emitting laser (VCSEL) diodes. The detection beams reflected from the object 108 pass through a receiving lens 110 which directs the reflected beams to a receiver 112 having photodetectors and associated amplifiers. The circuitry to control the emitters 104 and to process the signals from the receivers 112 is contained within a gate array 114. The microcontroller 102 works with the gate array 114 to control the transmission, reception and interpretation of the infrared light energy transmitted and received by the object detection system. The gate array 114 also functions to provide an interface between the emitters 104 and receivers 112 and the microprocessor 102. The gate array 114 further functions to produce a local oscillator (LO) signal that is combined with the receiver 112 signals in an analog mixer 116 to generate an intermediate frequency (IF) signal. A low pass filter 118 and high gain amplifier/limiter 120 are used to further condition the IF signal so that the output of the amplifier/limiter 120 provides a detection/no detection data signal that can be processed by the microcontroller 102. A lens test emitter and a lens test receiver may be provided to allow ambient conditions to be evaluated.

The gate array 114 is preferably a field programmable gate array (FPGA) that has been configured as described in more detail herein. Objects are detected by measuring differences between the transmitted and received waveforms, as further described in U.S. Pat. No. 6,377,167.

Referring now to FIG. 2, a functional block diagram of one embodiment of a gate array 202 constructed in accordance with the present invention is shown. The gate array 202 includes a clock generator circuit 206 that receives a clock input 204 from a 30 MHZ reference clock 205 (FIG. 1). The clock generator circuit 206 uses the received reference clock signal 204 to produce a number of derived clock signals that can selectively be accessed through a clock multiplexer 208 as directed by a set of control and status registers 210. The selected clock signal is provided to a set of transmit outputs 212 that are fed to the transmitters 104 (FIG. 1) of the object detection system 100. The selected clock signal from the clock multiplexer 208 is also provided to a receiver reference module 214 that provides delayed versions of the clock signal as a local oscillator signal to mixer 116 as shown in FIG. 1. The gate array 202 includes a microprocessor interface 216 that allows the gate array 202 to communicate with microprocessor 102 (FIG. 1). The control and status registers 210 also generate a receive enable signal that is provided to a receiver enable module 218 which enables the receivers of the vehicle object detection system. It will be readily appreciated by those skilled in the art that additional logic 220 may be provided in the gate array 202 as needed for particular applications of the present invention.

Referring now to FIG. 3, a block diagram of one embodiment of a receiver reference module is shown. The reference module includes a delay line 302 that is used to selectively delay the clock signal received from the output of the clock multiplexer as discussed in more detail below with respect FIG. 4. The amount of delay provided is selectively controlled by a calibration state machine 304 through multiplexer 306. Calibration feedback is fed from the delay line 302 output back to the calibration state machine 304 through a digital flip-flop (DFF) 308. A second flip-flop 310 and an AND gate 312 are used to enable to the sending of the receiver reference signal generated by the delay line 302 to the receiver 112.

Referring now to FIG. 4, a schematic diagram of the delay line arranged in accordance with one embodiment of the present invention is shown. The delay line (sometimes referred to as a delay module) implements a selectable delay for use in the object detection system receiver mixer/demodulator. The delay line preferably includes of a series of ninety-six three delay stages series connected input-to-output. A different number of delay stages can be used, depending on the particular application. The delay stages can be buffers 402 in the gate array 114 that are hard wired in series as shown. Thus, the input to the first buffer 402 is the output of the clock multiplexer 208 shown in FIG. 2. The output of each buffer 402 is connected by a one of a series of corresponding buffer taps 405 to the input of a 64-to-1 multiplexer 404. A tap select line 406 is used to control the multiplexer 306 to selectively connect one of the buffer taps 405 to the multiplexer output 408. The output 408 of the multiplexer 306 is the delayed signal 408. The delayed signal 408 is fed back to the calibration state machine 304 through DFF 308. The DFF 308 is controlled by a signal from the reference clock 305 (FIG. 1) that is delayed by three buffers as shown on FIG. 4. This synchronizes the signal 412 with the delayed output 408 when the delay line 402 is bypassed by selecting the first buffer tap line 405.

Referring now to FIGS. 5(a)-(d), four panels, A, B, C and D, depict the relationship between the timing of the clock reference signal 420, the calibration feedback signal 422 and the output 424 of DFF 308. In panel A, the tap select is equal to tap four and the calibration feedback signal 422 is delayed with respect to the clock reference signal 420 by an amount that is substantially less than one clock cycle. In such a situation, the output 424 of DFF 308 sent to the calibration state machine 304 remains low. In panel B, the tap select is set to tap fifteen and the feedback signal 422 is delayed for slightly more than one half clock cycle with respect to the clock reference signal 420. The output 424 of DFF 308 transitions high in panel B because the feed back signal 422 is now high when the clock reference signal 420 transitions high. In panel C, the tap select is set to tap 26 which results in a delay in the feedback signal 422 with respect to the clock reference signal 420 of slightly less than one clock cycle. In such a situation, the DFF output 424 remains high because the feedback signal 422 transitions high at approximately the same time as the clock reference signal 420 transitions high. Finally, in panel D, the tap select is set to tap 27 such that the DFF output 424 is now low because the feedback signal 422 has been delayed with respect to the clock reference signal 420 such that the feed back signal 422 is now low when the clock reference signal 420 transitions high. The transition in the DFF output 424 from a high value to a low value between a tap select value of 26 and a tap select value of 27 indicates that a tap select value of 27 provides a delay of at least one clock cycle. Thus, by incrementally moving through the line of delay buffers 402, the DFF output 424 can be used to determine the number of delay buffers 402 needed to delay the reference clock 420 by one clock cycle. Furthermore, since the number of buffers 402 needed to delay the clock 420 by one clock cycle can be periodically recalculated during processing, the delay circuit can compensate for variations in buffer 402 delays due to changed operating conditions or component tolerances.

Referring now to FIG. 5, a block diagram of a preferred calibration state machine 304 arranged in accordance with an embodiment of the present invention is shown. The calibration state machine 304 periodically performs a calibration routine on the delay line or module 302 discussed in more detail above. The output of the calibration state machine 304 is the calibration tap index 504, which represents the number of delay buffers needed to delay the reference signal one clock period, and the half period calibration state index 506, which indicates the number of delay buffers needed to delay the reference signal one half clock period.

The calibration state machine 304 has three inputs 508, 510 and 512. These inputs are the calibration feed back signal 508 from the delay line 302, the calibration trigger 510 which initiates a new calibration cycle and a reset 512 which resets the calibration state machine 304 and clears all registers and counters. The calibration feedback input 508 is the feedback through the delay line that has been routed through a D flip-flop. The calibration trigger 510 and calibration machine reset 512 inputs are connected to the microcontroller 102 (FIG. 1) so that the controller 102 can actively manage the calibration of the object detection system. A multiplexer control output 514 allows the calibration state machine 304 to access a particular tap in the delay line 302 through the multiplexer 306 as discussed in more detail above. A multiplexer enable output 516 is used to enable the tap select multiplexer 306. The clock control output 518 allows to the calibration state machine 304 to select a clock frequency using the clock multiplexer 208 shown in FIG. 2 and the clock enable output 520 enables control of the clock multiplexer 208. An error output 522 is provided such that the calibration state machine 304 can provide an indication to other components in the system that the calibration cycle did not succeed. A busy output 524 is also provided to allow the other system components to determine that a calibration cycle is in progress.

Although the self-calibration methods described herein are shown as implemented in an FPGA, these methods can also be performed in other embodiments, including combinations of discrete electronic components and/or combinations of digital hardware and software. If an FPGA is used, one example that can be programmed to function as described herein is the EX128 family from Octel.

Thus, although there have been described particular embodiments of the present invention of a new and useful “Self-Calibrating Object Detection System,” it is not intended that such references be construed as limitations upon the scope of this invention except as set forth in the following claims.

What is claimed is:

1. A compensation and calibration circuit for adjusting a delay signal to compensate for variations in operating conditions and component tolerances in an electronic system, said circuit comprising:
a reference generator for generating a reference signal;
a delay line comprising a delay line input and a plurality of delay stages, the delay line input electrically coupled to receive said reference signal, each of said delay stages having respective delay stage inputs and outputs and an associated propagation delay, wherein the propagation delays associated with each delay stage can vary in accordance with operating conditions and component tolerances;
the delay stage inputs and outputs are electrically connected in series to sequentially delay the reference signal by an amount proportional to the cumulative propagation delays associated with the respective delay stages;
a plurality of electrical taps, one of each of said electrical taps electrically connected to one of each of the outputs of each of said delay stages;
a multiplexer having a plurality of multiplexer inputs, one of each of said multiplexer inputs electrically coupled to one of each of said electrical taps, the multiplexer further comprising a multiplexer output and logic functional to selectively electrically couple one of each of said multiplexer inputs to said multiplexer output;
control logic operatively connected to said reference signal and to said multiplexer, the control logic functional to delay said reference signal by a desired amount by selecting a multiplexer input to couple to said multiplexer output wherein said selected multiplexer input corresponds to said desired delay amount; and
wherein said control logic periodically recalculates the cumulative delay associated with said delay stages such that changes in said propagation delays of said delay stages caused by variations in component tolerances and operating conditions are compensated for over time.

2. The compensation and calibration circuit of claim 1 wherein said reference signal is a clock signal and wherein the cumulative delay associated with said delay stages is recalculated by measuring the number of delay stages required to delay said reference signal by one clock cycle.

3. The compensation and calibration circuit of claim 2 further comprising calculating a calibrated tap index based upon said number of taps required to delay said clock signal one clock cycle.

4. The compensation and calibration circuit of claim 3 wherein a tap select signal is generated for said multiplexer by said control logic based upon said calibrated tap index and said desired delay.

5. The compensation and calibration circuit of claim 1 wherein said electronic circuit includes a field programmable gate array.

6. An object detection system for a vehicle, said object detection system comprising:
a clock generator for generating a clock signal;
a set of emitters for producing and transmitting a sensing beam;
a set of receivers for receiving reflected portions of said transmitted sensing beam;
a microprocessor for controlling said object detection system;
a gate array for receiving control signals from said microprocessor and producing transmit signals for said emitters and reference signals for said receivers wherein said gate array generates a delayed signal for use by said receivers, said gate array comprising:
a delay line comprising a string of series connected buffers for receiving said clock signal wherein each of said buffers has an associated propagation delay;
a series of electrical taps wherein one of said electrical taps is electrically connected after each of said buffers in said string of series connected buffers;
a multiplexer for receiving each of said series of electrical taps with a multiplexer input and selectively connecting one of said multiplexer inputs to a multiplexer output; and
control logic for delaying said clock signal by a desired amount to generate said delayed signal by selecting a multiplexer input to connect to said multiplexer output wherein said selected multiplexer input corresponds to said desired delay amount and wherein said control logic periodically recalculates a delay associated with said buffers such that changes in said propagation delays of said buffers are compensated for over time.
